(19) United States
(12) Patent Application Publication
(10) Pub. No.: US 2008/0280125 A1
(43) Pub. Date: Nov. 13, 2008

(54) Components with A Conductive Copper Sulfide Skin

(76) Inventors: Gary Allen Denton, Lexington, KY (US); James Joseph Semler, Lexington, KY (US)

Correspondence Address: LEXMARK INTERNATIONAL, INC.;INTELLECTUAL PROPERTY LAW DEPARTMENT, 740 WEST NEW CIRCLE ROAD, BLDG. 082-1, LEXINGTON, KY, 40550-0999, US

(21) Appl. No.: 11/745,495

(22) Filed: May 8, 2007

(51) Int. Cl. B32B 9/00; B05D 5/12

(52) U.S. Cl. 428/318.4; 427/123

(57) ABSTRACT

The present disclosure relates to a conductive component that may be used in an image forming device. The component includes a compressible material such as open cell foam having external and internal surfaces and a conductive material disposed thereon to a selected thickness. The conductive material includes copper sulfide.

### CROSS REFERENCES TO RELATED APPLICATIONS

None.

### STATEMENT REGARDING FEDERALLY SPONSORED RESEARCH OR DEVELOPMENT

None.

### REFERENCE TO SEQUENTIAL LISTINGS, ETC.

None.

### BACKGROUND

1. Field of the Invention

The present invention relates generally to components within an image forming apparatus, such as toner adder rollers, that may be rendered conductive. The component may utilize a conductive material additive such as copper sulfide.

2. Description of the Related Art

Many image forming devices, such as printers, copiers, fax machines, or multi-functional machines, utilize toner to form images on media or paper. The image forming apparatus may transfer the toner from a reservoir to the media via a developer system utilizing differential charges generated between the toner particles and the various components in the developer system. IN particular, one or more toner adder rolls may be included in the developer system, which may transfer the toner from the reservoir to a developer roller. The developer roll may then apply the toner to a selectively charged photoconductive substrate forming an image thereon, which may then be transferred to the media. In addition, other conductive components may be utilized in an image forming device to perform various other functions, such as charge rollers for charging the photoconductive element, cleaning rollers for cleaning the photoconductive element, or transfer rollers to aid in transferring toner from the photoconductor to the desired media.

### SUMMARY OF THE INVENTION

An exemplary aspect of the present disclosure relates to a conductive component comprising an image forming device component including a compressible open-cell foam material having external and internal surfaces. A conductive material may then be disposed on the surfaces wherein the conductive layer comprises copper sulfide at a thickness in the range of about 0.001 μm to about 5.0 μm. The compressible open-cell foam material may have a Shore 00 Hardness of about 20 to about 70 and about 50 to about 250 pores per linear inch.

Another exemplary aspect of the present disclosure relates to a method of forming a conductive component for use within an image forming device and/or image forming device cartridge. The method includes treating an image forming device component having compressible open-cell foam material having external and internal surfaces with copper ions and treating the compressible material with a sulfur containing compound. Copper sulfide may then be formed on the surfaces at a thickness in the range of about 0.001 μm to about 5.0 μm.

### BRIEF DESCRIPTION OF THE DRAWINGS

The above-mentioned and other features and advantages of this invention, and the manner of attaining them, will become more apparent and the invention will be better understood by reference to the following description of embodiments of the invention taken in conjunction with the accompanying drawings, wherein:

FIG. 1 is a perspective view of an exemplary conductive component.

FIG. 2 is a cross sectional view of the exemplary conductive component of FIG. 1;

FIG. 3 is an expanded exemplary view of a portion of the surface of an open cell foam treated with CuₓS_{y} additive illustrating the additive on external and internal surfaces of the foam material.

FIG. 4 is a cross sectional view of an exemplary developer system in an image forming apparatus including a conductive component in the form of a toner adder roll.

### DETAILED DESCRIPTION

It is to be understood that the invention is not limited in its application to the details of construction and the arrangement of components set forth in the following description or illustrated in the drawings. The invention is capable of other embodiments and of being practices or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted,” and variations thereof herein are used broadly and encompass direct and indirect connections, couplings, and mountings. In addition, the terms “connected” and “coupled” and variations thereof are not restricted to physical or mechanical connections or couplings.

The present disclosure relates to conductive components within a developer system or more generally in an image forming apparatus. As noted, an image forming apparatus may include printers, copiers, fax machines, multi-functional machines, that employ an image forming substance, such as toner, to form an image on a given substrate (e.g. paper). The conductive components may be utilized, for example, to transfer toner from a reservoir to a photoconductive substrate and/or to the media. The conductive components may also be utilized as charging components or cleaning components, to charge and/or clean the photoconductive substrate.

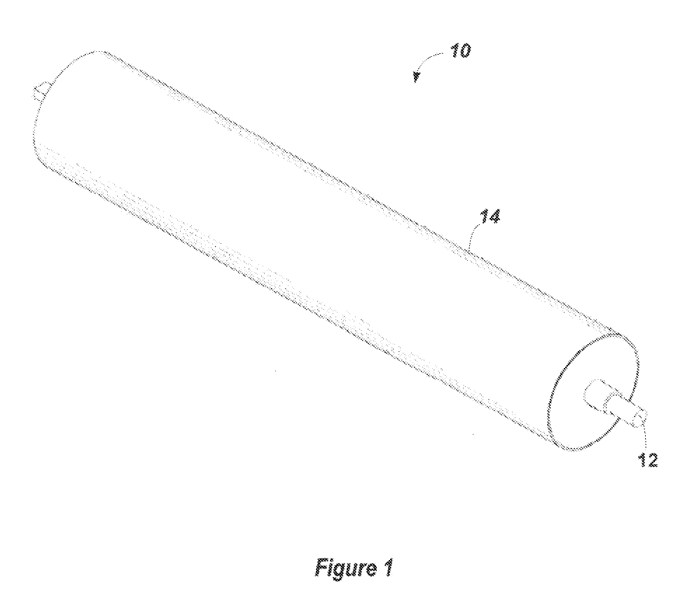

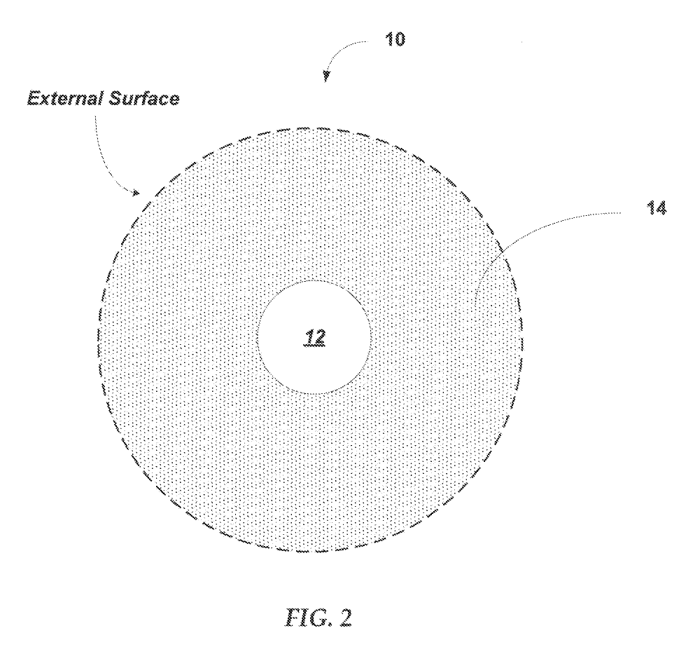

Turning to FIGS. 1 and 2, the conductive component 10 may take on the form of a roller, wherein the roller may include a shaft 12, a compressible material 14 surrounding all or at least a portion of the shaft. An adhesive layer (not illustrated) may optionally be included between the shaft and foam layer. The shaft 12 may include a conductive material. The conductive material may form the entirety of the shaft or may be used to coat the shaft, wherein the shaft may be a polymeric material. The roller may be contained in an electrophotographic printer cartridge or an electrophotographic printer.

The compressible material may include a polymeric material such as thermoplastic or thermoset (crosslinked) resin. By compressible, it should be understood that the material may have a Shore 00 Hardness of about 20-70, including all values and increments therein. For example, the Shore 00 Hardness may be about 30-50. The polymeric material may include materials such as urethanes, polyisoprene, silicone, EPDM, etc. The compressible material may also include electrically conductive additives, such as various metal powders including gold, nickel, silver, copper, aluminum, etc., carbon black, ionic salts, combinations thereof, etc. The compressible material may have a coefficient of friction, relative to 20 lb. bond paper, of less than or equal about 2.5, including all increments and values therein, such as in the range of about 0.9 to 2.1.

However, it should be noted here that the electrically conductive additives noted above may be completely eliminated and, with respect to electrical conductivity considerations, the present disclosure may rely exclusively on the use of copper sulfide. For example, with respect to the incorporation of carbon black via slurry type coatings, such coatings may have the associated problem of flaking, and typically require the use of polyols, such as poly(ethylene glycol) and ply(propylene glycol) which may be used as a dispersion medium. Such polyols may therefore undesirably influence electrical charging properties Furthermore, the use of conductive additives such as ionic salts may be moisture sensitive, and again, by elimination of such additive, moisture sensitivity of the image forming device component may be avoided thereby reducing or eliminating any change in electrical resistivity that may occur with ionic salt treatment.

Accordingly, the present disclosure relates to a compressible material, consisting essentially of conductive material (copper sulfide). It is therefore contemplated that the open cell foam may utilize copper sulfide, and other additional conductive additive materials examples of which include carbon black and/or ionic salts. However, the level of such other conductive material may be less than or equal to about 20.0% by weight of the compressible material. For example, such other conductive materials may be present at a level of about 0.1-20% by weight of the compressible material, including all values and increments therein. In addition, the present disclosure also relates to a compressible material consisting only of conductive material (copper sulfide) without the need for and completely free of other additional conductive materials, such as, once again, carbon black and/or ionic salts.

The compressible material herein may specifically include foam formed from a polymeric material such as urethanes, polyisoprene, silicone, EPDM, etc. Foam may be understood as any material that provides a cellular type structure. The foam may therefore be open cell, wherein at least 50% of the cell walls are broken or open to adjacent cells wherein the cells may still be interconnected in such a manner that gas may still pass from one cell to another. Accordingly, the relative percent of open cells may be present in the range of 50-100%, including all values and increments therein. The foam may also have a density in the range of about 0.1 to 9 pounds per cubic foot, including all values and increments therein. In addition, the foam may have an average cell size in the range of about 100 μm to about 450 μm, including all increments and values therein, such as about 150 μm, 200 μm, etc. Furthermore, the foam may have a number of pores per linear inch of between about 50 to about 250, including all values and increments therein. For example, the number of pores per linear inch may be about 100 to about 175.

The compressible material 14 may therefore include copper sulfide which may be applied to the open cell foam which may then permeate the compressible material (e.g. open cell foam) and reside in the surfaces of the polymer material that may form the open-cell foam structure. In such manner the copper sulfide may provide a conductivity to the foam and triboelectric charging when interacting with toner. In addition, as discussed more fully below, the copper sulfide treatment may be configured so that the mechanical properties of the foam, noted above, are not adversely influenced.

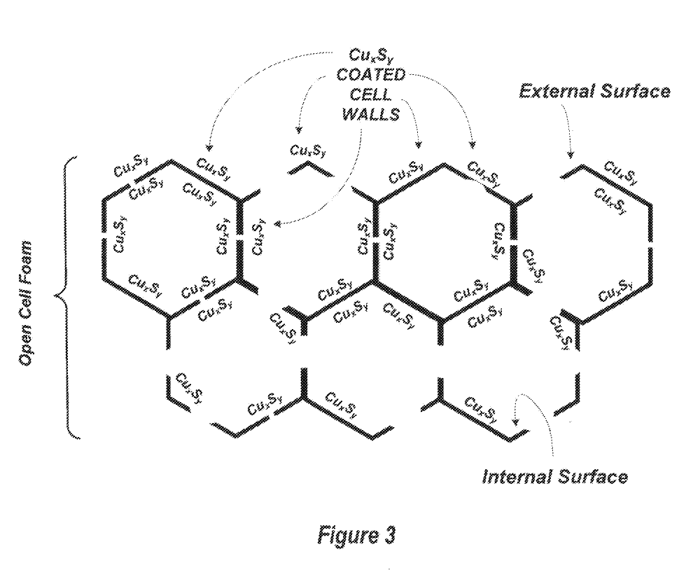

Attention is therefore directed to FIG. 3 which shows a magnified portion of a portion of an exemplary open cell foam. As illustrated, the pores may be relatively hexagonal, but a variety of other geometries are possible, including spherical, round, trapezoidal, and/or rectangular, etc. FIG. 3 is therefore intended to illustrate that the copper sulfide may substantially coat the polymeric material. In addition, the polymeric material forming the open cell foam defines an external surface as well as internal surface which internal surface may be located inside the pores and the copper sulfide may therefore be present at either or both surface locations. The external surface may be therefore the exposed surface of a roller that engages with toner (see again, FIG. 2). In addition, the actual thickness of the coating on the polymer material at any point on or within the open cell foam structure (i.e. the external and/or internal surfaces) may be about 0.001 μm to about 5 μm, including all values and increments therein. By maintaining the thickness of the copper sulfide in such manner, and as noted above, the mechanical properties of the foam (e.g., Shore 00 Hardness values of between about 20-70) may remain in such range as desired for use in an image forming device component.

It is therefore contemplated that the compressible material may be treated with a sulfur containing compound and copper ions. The sulfur containing compound may be in gas form or may be mixed into an aqueous solution. For example, in gaseous form, the compressible material may be treated with hydrogen sulfide under pressure. In an exemplary embodiment, the compressible material may be treated with the hydrogen sulfide in a vessel, such as an autoclave, under pressure in the range of about 1 to 10 kg per square centimeter. In an aqueous solution, the compressible material may also be treated using sulfur containing compounds such as thioacetamide or thiourea. The sulfur compounds ay be present in the range of about 1 to 20% by weight, including all increments and values therein. Treating the compressible material with the sulfur containing compound may occur for a selected duration, such as about 1 minute to 5 hours, including all values and increments therein, such as 45 minutes to 2 hours, etc.

The compressible material may then be treated with a metal salt or complex in solution which may react with the sulfur compounds to provide a copper sulfide composition and coat the polymeric material of the exemplary open-cell foam. Exemplary salts or complexes may include salts or complexes of copper (cuprous or cupric) and more specifically may include cupric chloride, cuprous chloride, cupric sulfate cupric nitrate, et. Cuprous chloride may be supplied in an ammoniacal medium. The concentration of the metal salt in solution may be in the range of about 12 to 20% including all increments and values therein, such as 3-10%. The compressible material may be immersed in the solution for a duration of a few minutes to a few hours, including all values and increments therein, such as 1 minute to 5 hours, 45 minutes to 2 hours, etc. The resulting article may be rinsed and dried.

In a further exemplary embodiment, the conductivity may be provided by treating the compressible material in an aqueous bath of monovalent or divalent copper ions, which may include cupric compounds such as cupric sulfate, cupric chloride, cuprous chloride cupric nitrate, chelate compounds of copper, or combinations thereof. Divalent copper ions may be reduced to monovalent copper ions by the addition of a reducing agent which may include metallic copper, ferrous sulfate, ammonium vanadate, sodium hypophosphite, hydroxylamine sulfate, furfural, glucose, or combinations thereof.

In addition to the copper ions and/or the reducing agent, the bath may include the sulfur-containing compound which may provide sulfur atoms and/or sulfur ions for reacting with monovalent copper ions to produce copper sulfide. It should be appreciated, however, that the compressible (e.g. open-cell) material may be treated with the copper ions and sulfur-containing compound at the same time or separately (i.e., the sulfur-containing compound may be added before or after copper ion treatment). The sulfur containing compound may include sodium sulfide, sulfur dioxide, dithionous acid, sodium dithionite, sodium thiosulfate, sulfurous acid, sodium hydrogen sulfite, sodium pyrosulfite, thiourea dioxide, hydrogen sulfide, sodium hydroxymethylsulfinate (such as RONGALITE C or RONGALITE Z available from BASF), zinc formaldehyde sulfoxylate (such as DECROLINE or SAFOLIN) or combinations thereof. In addition, sulfur dioxide or hydrogen sulfide can be bubbled into the bath to provide the sulfur for reacting with the monovalent copper ions.

Furthermore, the pH of the bath containing the copper ions and/or the sulfur containing compound may optionally be adjusted. The pH of the bath may be adjusted by adding an acid or a salt of the bath. The acid may include inorganic acids such as sulfuric acid, phosphoric acid or hydrochloric acid; organic acids such as citric acid or acetic acid and mixtures thereof. Salts may include salts of the acids mentioned herein as well as sodium citrate, sodium acetate, disodium hydrogen phosphate, and mixtures thereof. Mixtures of acids and salts, such as citric acid and disodium hydrogen phosphate may also be used. The pH of the bath may optionally be adjusted within the range of about 1.5 to 6, including all increments and values therein.

The temperature of the bath may be adjusted within the range of about 10° C. to 150° C., including all values and increments therein. In addition, the heat-treatment in the bath may be in the range of a few minutes to a few hours, including all increments and ranges therein, such as 10 minutes to an hour, one hour to 5 hours, or one hour to one and a half hours.

In addition, a wetting agent may be added to the bath as well. Such wetting agent may include a non-ionic wetting agent such as a relatively low molecular weight alcohols (e.g. organic alcohols having a MW of ≦500) including methanol, ethanol, and/or isopropyl-alcohol. In addition, by utilizing a wetting agent, it may be appreciated that the surface tension of the compressible material (e.g. foam) may be reduced such that coating with the copper sulfide may proceed more efficiently. Other non-ionic wetting agents contemplated herein include poly(alkylene oxides) such as poly(ethylene oxide) and/or poly(propylene oxide).

Where the compressible material may be separately treated with the copper ions/reducing agent and the sulfur-containing compound, the compressible material may first be treated with the copper ions and/or the reducing agent. The temperature of the bath may be adjusted in the range of about 10 to 150° C., including all values and increments therein, and the compressible material may be treated for a few minutes to a few hours including all increments and ranges therein, such as one hour to one and a half hours. The pH of the bath may be adjusted to about 1.5 to about 4, including all increments and values therein. Optionally, the compressible material may be rinsed.

The compressible material may then be treated with the sulfur containing compounds in either an aqueous solution or by exposure to a sulfur compound containing gas. The sulfur containing compounds may be added in the same bath or a separate bath. The compressible material may be treated with the sulfur containing compounds at a temperature in the range of about 10° C. to 150° C., including all values and increments therein, and the foam may be treated for a few minutes to a few hours including all increments and ranges therein, such as one hour to one and a half hours. The pH of the bath may be adjusted to about 4 to about 6.5, including all increments and values therein.

Furthermore, as alluded to above, the copper ion treated compressible material may be exposed to a gas containing sulfur compounds, such as those mentioned above. For example, the copper ion treated compressible material may be placed into or passed through a receptacle into which a gaseous sulfur containing compounds is fed as a saturated vapor. The temperature may be in the range of 100° C. to 120° C., including all increments and values therein and the pressure in the receptacle may be allowed to reach about 0.5 to 1.5 kg/cm² gauge pressure, including all increments and values therein.

The treated compressible material may then be washed and dried. The resulting copper sulfide may include any compound of copper with sulfur wherein the copper and sulfur may be present at different stoichiometric levels (i.e. CuₓS_{y}) where x and y may numerically vary to provide a copper sulfide compound. Such compounds may therefore include CuS, Cu₂S or Cu₉S₆. The copper sulfide may be present in the range of 0.01 to 40% by weight of the compressible material, including all increments and values therein, such as in the range of 0.1 to 10% by weight of the compressible material. In addition, as noted above, the copper sulfide thickness on the compressible material may be about 0.001 μm to about 5 μm, including all values and increments therein. In particular, the thickness may be about 0.001 μm to about 1.0 μm, including all values and increments therein. In addition, the volume resistivity of the treated compressible material may be 10³ or less Ω-cm, including all values and increments therein such as 10¹ to 10²Ω-cm.

In another exemplary embodiment, the competent may be prepared by the method described above and then subjected to another aqueous solution or bath containing ions of a second metal. The second metal may be provided by a metal salt or complex, such as a metal sulfate, nitrate, chloride, acetate, benzoate, a thiocyanate complex or a thiosulfate complex. The second metal salt or complex may be provided in the solution at a concentration of about 0.005 to 20 gram per liter, including all values and increments therein, such as 0.01 to 6 grams per liter. The treatment with the second metal may occur at a temperature of about 10 to 150° C., including all increments and values therein, for a duration of a few minutes to 20 hours, including all increments and values therein, such as 10 minutes to 10 hours, etc.

The treatment with the second metal compound may be performed in the presence of a sulfur containing compound, or followed by treatment with a sulfur containing compound in either an aqueous mixture of gaseous form. The sulfur containing compounds may include sodium sulfide, sulfur dioxide, sodium hydrogen sulfite, sodium pyrosulfite, sulfurous acid, dithionous acid sodium dithronite, sodium thiosulfide, thiourea dioxide, hydrogen sulfide, sodium formaldehyde sulphoxylate, zinc formaldehyde sulphoxylate, or combinations thereof.

The ratio of the second metal sulfide to the first metal sulfide may be expressed in an atomic ratio of M₂/M₁ wherein M₁ is the first metal, M₂ is the second metal. The ratio of M₂/M₁ may be in the range of 0.0001 to 0.5, including all increments and values therein, such as 0.001-0.3, 0.01-0.2.

Once treated the compressible material may be applied to the shaft 12. For example, the compressible material may include a void volume therein through which the shaft 12 may be passed. In a further embodiment, the compressible material may be formed over the shaft 12 an then treated. An adhesive material may optionally be included between the compressible material and the shaft.

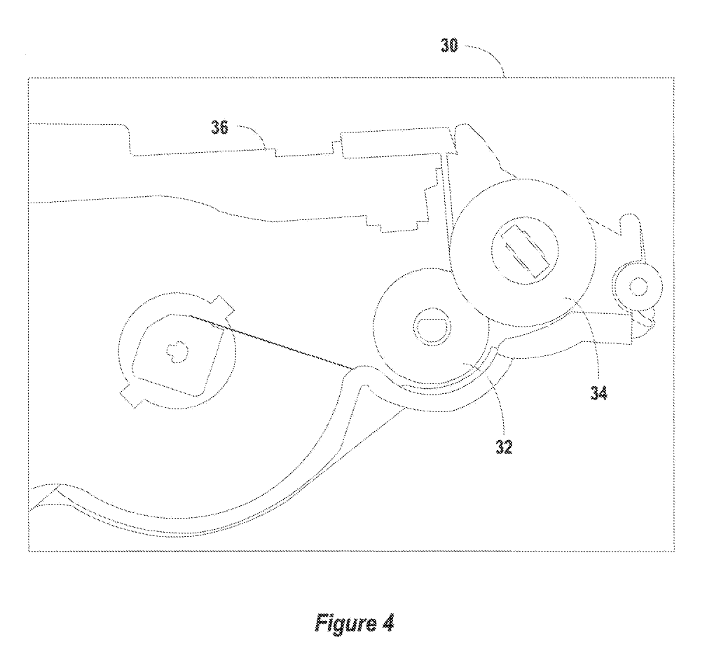

The component containing the conductive copper sulfide layer may be employed as a toner adder roller in a developer unit as illustrated in FIG. 4. For example, an image forming device 30 may include a component including a conductive skin such as toner adder roller 32. The toner adder roller 32 may pass toner to the developer roller 34. The developer roller 34 may then pass the toner to selectively charged areas of a photoconductive element (not illustrated). The toner adder roller 32 and developer roller 34 may be located in a toner cartridge 36, which may be removably positioned into the image forming device 30.

The foregoing description of several methods and an embodiment of the invention has been presented for purposes of illustration. It is not intended to be exhaustive or to limit the invention to the precise steps and/or forms disclosed, and obviously many modifications and variations are possible in light of the above teaching. It is intended that the scope of the invention be defined by the claims appended hereto.

What is claimed is:

1. A conductive component comprising:
an image forming device component including a compressible open-cell foam material having external and internal surfaces;
a conductive material disposed on said surfaces;
wherein said conductive material comprises copper sulfide having a thickness on said surfaces in the range of about 0.001 μm to about 5.0 μm.

2. The conductive component of claim 1 wherein said copper sulfide has a thickness on said surfaces in the range of about 0.001 to about 1 μm in thickness.

3. The conductive component of claim 1 wherein said copper sulfide is present by weight of the compressible material in the range of 0.01 to 40%.

4. The conductive component of claim 1 wherein said copper sulfide has the formula Cu₉S₅.

5. The conductive component of claim 1 wherein said compressible material including said copper sulfide has a volume resistivity of 10³ Ω-cm or less.

6. The conductive component of claim 1 wherein said compressible material has a Shore 00 Hardness of about 20 to about 70.

7. The conductive component of claim 1 wherein said compressible material has about 50-250 pores per linear inch.

8. The conductive component of claim 6 wherein said compressible material has an average cell size in the range of about 100 μm to 450 μm.

9. The conductive component of claim 1 wherein said compressible material is free of electrically conductive additives other than said copper sulfide.

10. The conductive component of claim 1 wherein said compressible material includes about 20% by weight or less of electrically conductive additive other than said copper sulfide.

11. The conductive component of claim 1 wherein said component is a roller in an electrophotographic printer cartridge.

12. The conductive component of claim 1 wherein said component is a roller in an electrophotographic printer.

13. A conductive component comprising:
an image forming device component including a compressible open-cell material having external and internal surfaces,
a conductive layer disposed on said surfaces wherein said conductive material comprises copper sulfide having the formula Cu₉S₆ having a thickness in the range of about 0.001 μm to about 5.0 μm.
said open cell compressible material comprising foam having about 50-250 pores per linear inch and a Shore 00 Hardness of about 20 to about 70.

14. The conductive component of claim 13 wherein said copper sulfide is present by weight of the compressible material in the range of 0.01 to 40%.

15. The conductive component of claim 13 wherein said compressible material including said copper sulfide has a volume resistivity of 10³ Ω-cm or less.

16. The conductive component of claim 13 wherein said compressible material comprises polyurethane foam.

17. The conductive component of claim 13 wherein said compressible material has an average cell size in the range of about 100 μm to 450 μm.

18. The conductive component of claim 13 wherein said component is a roller in an electrophotographic printer cartridge.

19. The conductive component of claim 13 wherein said component is a roller in an electrophotographic printer.

20. A method of forming a conductive component comprising:
treating an image forming device component including a compressible open-cell foam material having external and internal surfaces with copper ions;
treating an compressible material with a sulfur containing compound; and
forming a copper sulfide on said external and internal surfaces wherein said copper sulfide has a thickness in the range of about 0.001 μm to about 5.0 μm.

21. The method of claim 20, wherein said compressible open-cell foam material has about 50-250 pores per linear inch and a Shore 00 Hardness of about 20 to about 70.

22. The method of claim 20 wherein said copper sulfide comprises Cu₉S₅.
